(19) United States
(12) Patent Application Publication
(10) Pub. No.: US 2004/0131989 A1
(43) Pub. Date: Jul. 8, 2004

(54) Orthodontic apparatus

(76) Inventor: Eugene Lee Dellinger, Fort Wayne, IN (US)

Correspondence Address: BAKER & DANIELS, 111 E. WAYNE STREET, SUITE 800, FORT WAYNE, IN, 46802

(21) Appl. No.: 10/338,342

(22) Filed: Jan. 8, 2003

(51) Int. Cl. A61C 3/00

(52) U.S. Cl. 433/18; 433/22; 433/20

(57) ABSTRACT

An orthodontic apparatus having a tube shaped attachment. A wire is threaded through the attachment, the wire having a shape whereby it can generate torsional forces on the attachment. The attachment may be secured to either a primary bracket which is secured to a tooth or to a primary wire. Either the primary arch wire can be used in conjunction with the attachment or a secondary wire can be used in addition to a primary wire. By way of this arrangement, forces can be generated along and around all three major axes.

### BACKGROUND OF THE INVENTION

1. Field of the Invention

This invention relates to an orthodontic apparatus, and in particular to an orthodontic apparatus for moving a tooth upward, downward, for tipping the tooth, rotating the tooth, for changing axial inclinations, and for applying torque to the tooth in a finite manner.

Conventional orthodontic techniques include straight wire orthodontic bracket systems in which all the necessary angles and planes of movement are manufactured directly into the brackets. Such brackets attempt to provide directly with the brackets all the necessary movements, such as tipping, torquing, in and out requirements, and other movements. Such straight wire appliances are designed to allow the force and resilience of unbent arch wires to guide the teeth into the appropriate positions.

Conventionally, stainless steel wires have been used for orthodontic appliances. The orthodontist would select the appropriate size of the wire and then bend the wire into the desired configurations so that the wire, and the appliance, would have the desired characteristics.

One of the difficulties in using prior art orthodontic devices has been the assumption that all teeth are identical and that one size of orthodontic apparatus fits all. In reality, teeth vary very much both anatomically and morphologically.

Ideally, an orthodontic appliance would create an appropriate load deflection force level for a tooth, which force acts over a long deflection distance. However, in reality the deflection distances over which conventional wires work are quite small. The wires themselves are quite small, and the distances of the wires from the brackets are also quite short. With those small dimensions, if one fills up a bracket slot with a wire and then attempts to bend the wire, the forces become very harsh and the load deflection properties are inappropriate. In particular, torque forces are difficult to create because, in order to obtain a good hold on a bracket, a fairly large wire is needed. However, if one puts a crink or bend in a fairly large wire, the load deflection is unacceptable. What is frequently used in these situations is an overlay wire. However, this too has not been an acceptable solution to the problem as complicated bending of the wire by the clinician is required and load deflection rates are still not ideal.

Prior art stainless steel wires have the disadvantage that, in relatively short lengths of wire, they do not provide a constant deflection force over large deflection distances. Thus, in prior art orthodontic arrangements, long lengths of stainless steel wires have been used by building length into the wire, i.e., by providing the wire with a series of geometric bends, twists, and turns in order to make the deflection force more constant over larger deflection distances.

More recently titanium-based alloy arch wires, such as nitinol wires, have been considered very suitable for orthodontics, particularly in comparison to stainless steel wires, due to the low force these wires impart coupled with their very good shape memory. The super elasticity of such wires is more bio-compatible. However, it is virtually impossible for an orthodontist to bend such titanium-based arch wires to create torque, due to the resistance of such wires to permanent deformation. Orthodontists are therefore limited to the high forces and low shape memory of stainless steel wires for final torque movements, as opposed to the more bio-compatible forces of titanium-based alloy wires.

Several methods have been used for attaching arch wires to brackets. Stainless steel ligatures have been used to tie the arch wire in place. Plastic rings have also been used, which are stretched around the brackets to hold the arch wire in place. A variety of mechanical fasteners such as clip and snaps have also been used to secure arch wires to brackets. None of these methods are completely satisfactory.

It is therefore desired to provide an orthodontic apparatus wherein titanium-based alloy wires, such as nitinol wires, other super elastic wires, stainless steel wires, or plastic type of wires, may be used to create torque and acceptable relatively constant deflection forces for acting on a tooth over large deflection distances.

It is also desired to provide an orthodontic apparatus for providing relatively constant deflection forces on teeth over large deflection distances, and to move and rotate a tooth around and along all three major axes, as desired.

It is furthermore desired to provide such an apparatus which is simple and easy to install.

### SUMMARY OF THE INVENTION

The instant invention provides an orthodontic appliance wherein both a primary bracket and a secondary attachment are used and wherein the secondary attachment is used to apply torque or other forces created by a wire, to a tooth.

The invention includes a primary bracket and a secondary attachment. The secondary attachment is in the shape of a small tube. The aperture in the tube is such that torsional or other forces can be created when a wire is disposed in the aperture. The torsional forces or other forces act over a relatively long deflection distance at a low load deflection rate.

Various arrangements of a primary bracket and secondary attachment may be used. The secondary attachment may be secured to either the primary bracket, or to a primary wire. Both a primary and a secondary wire may be used as further discussed hereinafter.

### BRIEF DESCRIPTION OF THE DRAWINGS

The above mentioned and other features and objects of this invention, and the manner of attaining them, will become more apparent, and the invention itself will be better understood by reference to the following description of an embodiment of the invention taken in conjunction with the accompanying drawings, wherein:

FIG. 1 is a plan view of a set of upper teeth to which an orthodontic apparatus, according to the invention, has been attached;

FIG. 2 is a side elevational view of a tooth to which both a primary bracket and a secondary attachment have been attached;

FIG. 3 shows an enlarged side elevational view of the primary bracket and the secondary attachment of FIG. 2;

FIG. 4 is a side elevational view of a set of upper teeth to which primary brackets and an arch wire have been attached;

FIG. 5 is a perspective view of a primary bracket;

FIG. 6 is a plan view of the tooth of FIG. 2 indicating movement of the tooth along a horizontal axis which runs from the front of the tooth to the back of the tooth;

FIG. 7 is a front elevational view of the tooth of FIG. 2 showing sideways movement of the tooth along the horizontal axis of the tooth which runs parallel to the front of the tooth;

FIG. 8 is a side view of the tooth of FIG. 2 showing up and down movement of the tooth along a vertical axis;

FIG. 9 is an elevational view of an attachment which would create neither tipping nor rotation of a tooth;

FIG. 10 shows an elevational view of an attachment which would create tipping of a tooth in a first direction;

FIG. 11 shows an elevational view of an attachment which would create tipping of a tooth in an opposite direction of the attachment of FIG. 10;

FIG. 12 shows an elevational view of an attachment which would create rotation of a tooth along a vertical axis;

FIG. 13 shows a plan view of a set of upper teeth wherein only a primary wire is used and wherein an attachment is secured to the primary wire;

FIG. 14 shows a perspective view of a primary bracket wherein the arch wire can rotate in the bracket;

FIG. 15 is an elevational view of an embodiment of an attachment according to the invention for use in anchoring a secondary wire to a primary wire;

FIGS. 16-19 show a primary bracket and an attachment wherein the attachment creates varying amounts of rotational tension in the secondary wire;

FIG. 20 shows an alternate embodiment of an attachment according to the invention for connecting an attachment to a primary bracket; and

FIG. 21 shows a top view of the embodiment of the attachment according to FIG. 20 secured to the primary bracket which in turn is secured to a tooth.

Corresponding reference characters indicate corresponding parts throughout the several views. The exemplifications set out herein illustrate preferred embodiments of the invention and such exemplifications are not to be construed as limiting the scope of the invention in any manner.

### DESCRIPTION OF THE PREFERRED EMBODIMENT

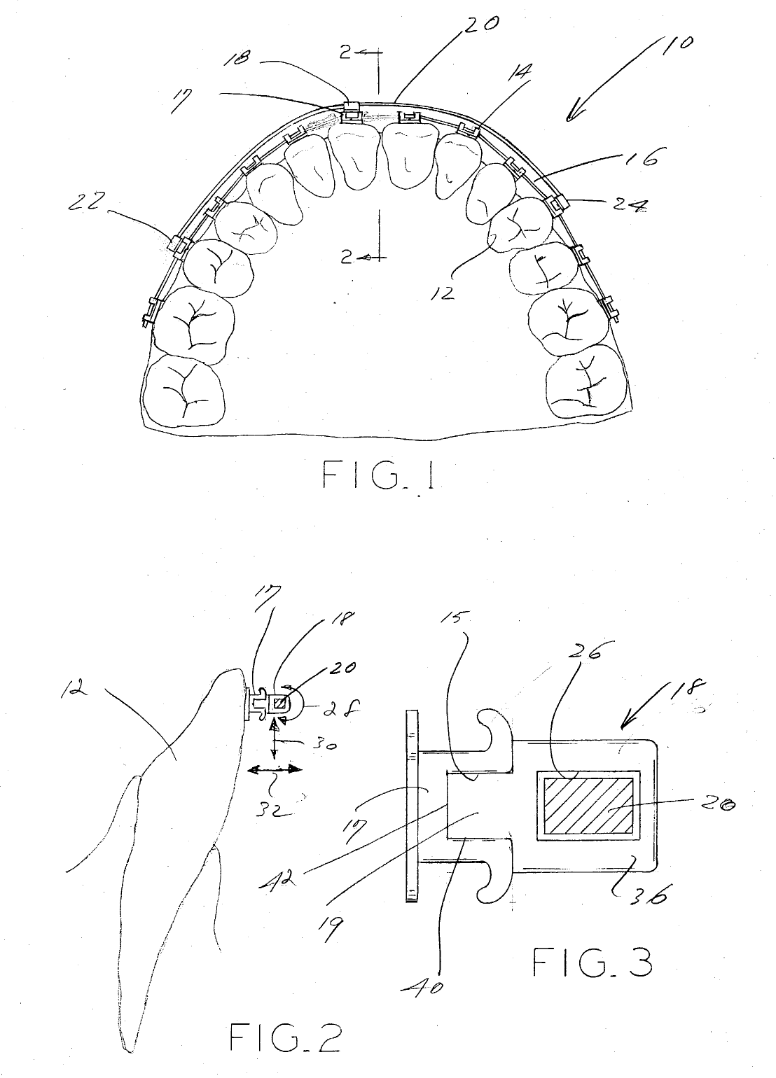

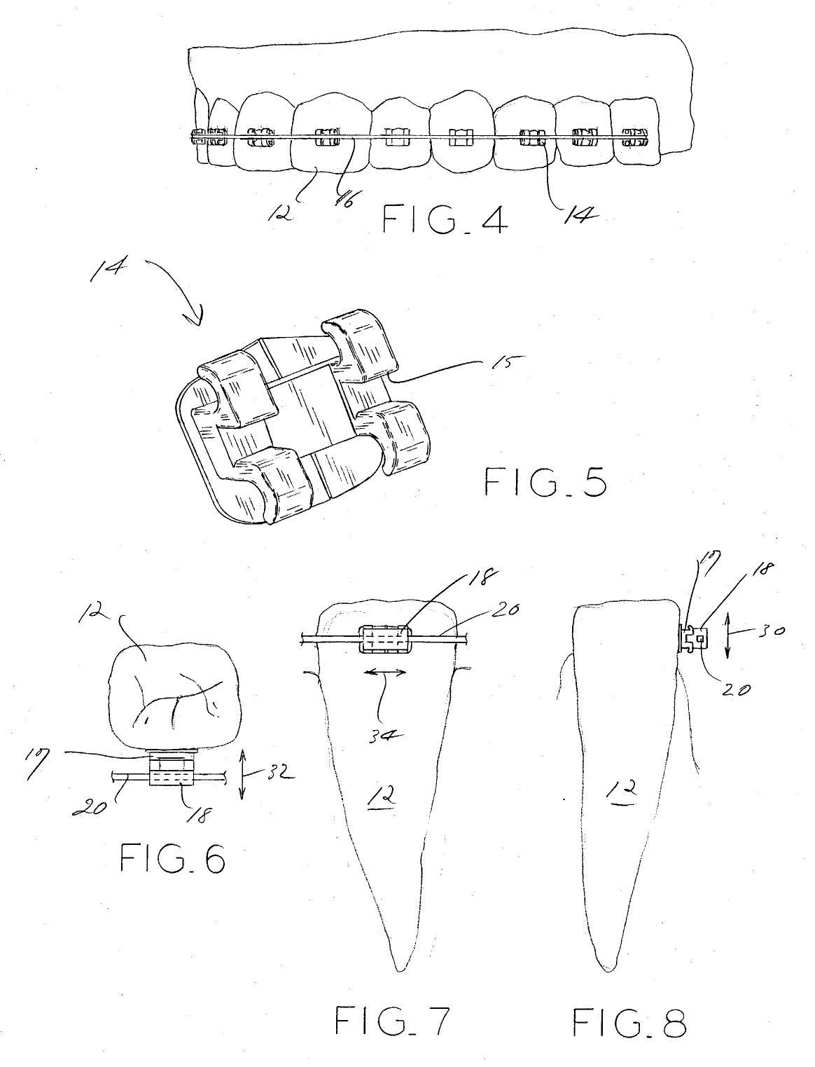

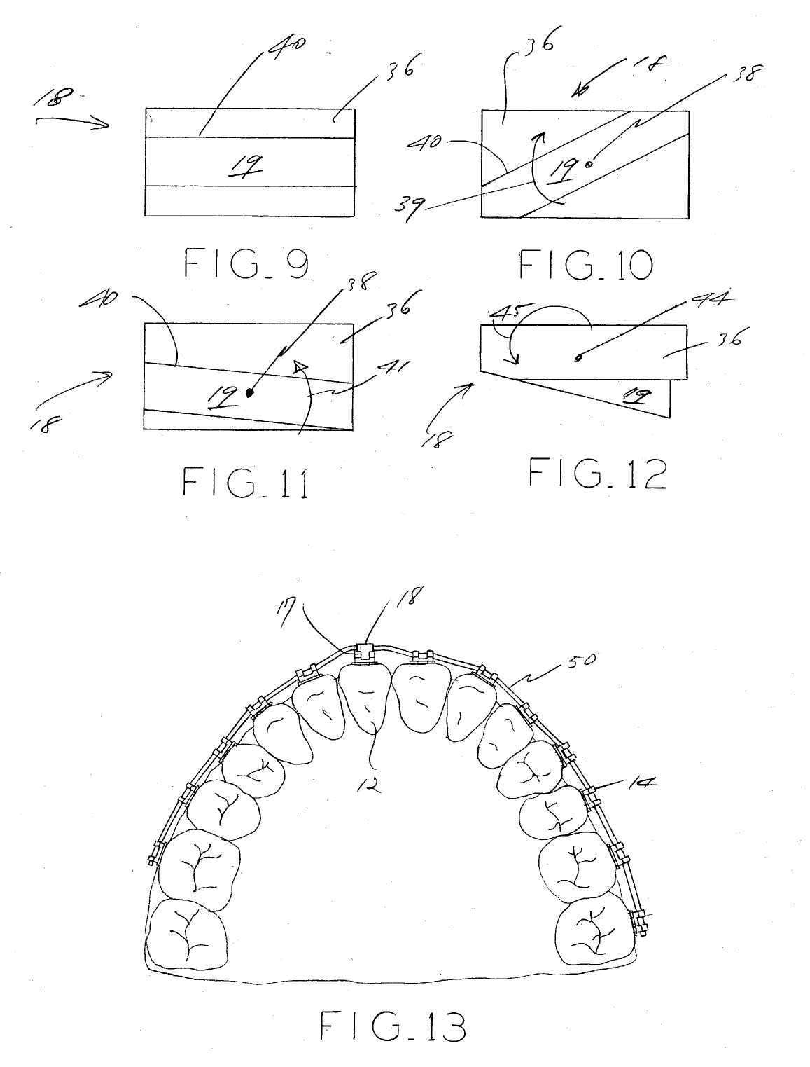

Referring to FIG. 1, there is shown a set 10 of upper permanent teeth which includes individual teeth 12. Attached to the individual teeth 12 are primary brackets 14 which are secured to the teeth by means of an adhesive or the like. Primary brackets are conventionally made of stainless steel, plastic, or ceramic materials. FIG. 4 discloses an elevational view of a conventional primary wire 16 and primary brackets 14 which are secured to teeth 12. FIG. 5 shows an enlarged perspective view of primary bracket 14. Primary brackets 14 each include a slot 15 in which an arch wire 16 is firmly clasped. Arch wire 16 permits the teeth to be moved sideways in the lengthwise direction of wire 16 as determined by applied force of wire 16. A secondary bracket or attachment 18 is also secured to one of the primary brackets 17. Primary bracket 17 is not engaged by arch wire 16. Attachment 18 is secured in slot 15 of primary bracket 17.

FIG. 3 shows an enlarged view of primary bracket 17 to which attachment 18 has been secured. Attachment 18 includes an extension or a securement portion 19 comprising a portion of reduced height which is captured in slot 15 of primary bracket 17 and is firmly secured thereto by any suitable securement method such as clamping, an adhesive, or the like. It should be noted that portion 19 can be of any suitable shape which allows it to be captured in a slot 15 of primary bracket 17.

Attachment 18 includes a rectangular aperture 26. Attachment 18 therefore comprises a small section of tube which is arranged so that tube aperture 26 is parallel to the lengthwise direction of primary wire 16. Attachment 18 may be made of metal, ceramic, or other suitable materials.

A secondary wire 20 is threaded through aperture 26 of attachment 18. Secondary wire 20 may be either slidingly engaged by attachment 18 or may be fixedly secured thereto, as desired. When secondary wire 20 is slidingly engaged by attachment 18, no forces will be placed on the secondary bracket in the lengthwise direction of secondary wire 20. Secondary wire 20 is secured to two primary brackets 14 by two anchor brackets 22 and 24 which are located a substantial distance from attachment 18, as shown in FIG. 1. Alternatively, secondary wire 20 may be attached to two tube attachments of the type shown in FIG. 15 and described hereinafter, which, in turn, are attached to primary arch wire 16. It can be seen, in the illustration of FIG. 1, that anchor brackets 22, 24 are located four teeth away from tooth 12 to which attachment 18 is secured. However, other spacings may be used, as desired. Secondary wire 20 is preferably made of a titanium alloy, such as nitinol or any other suitable elastic wire.

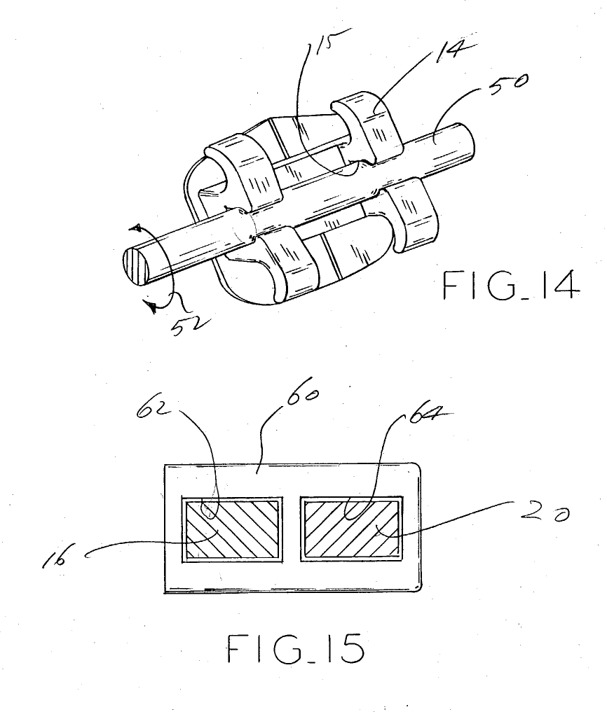

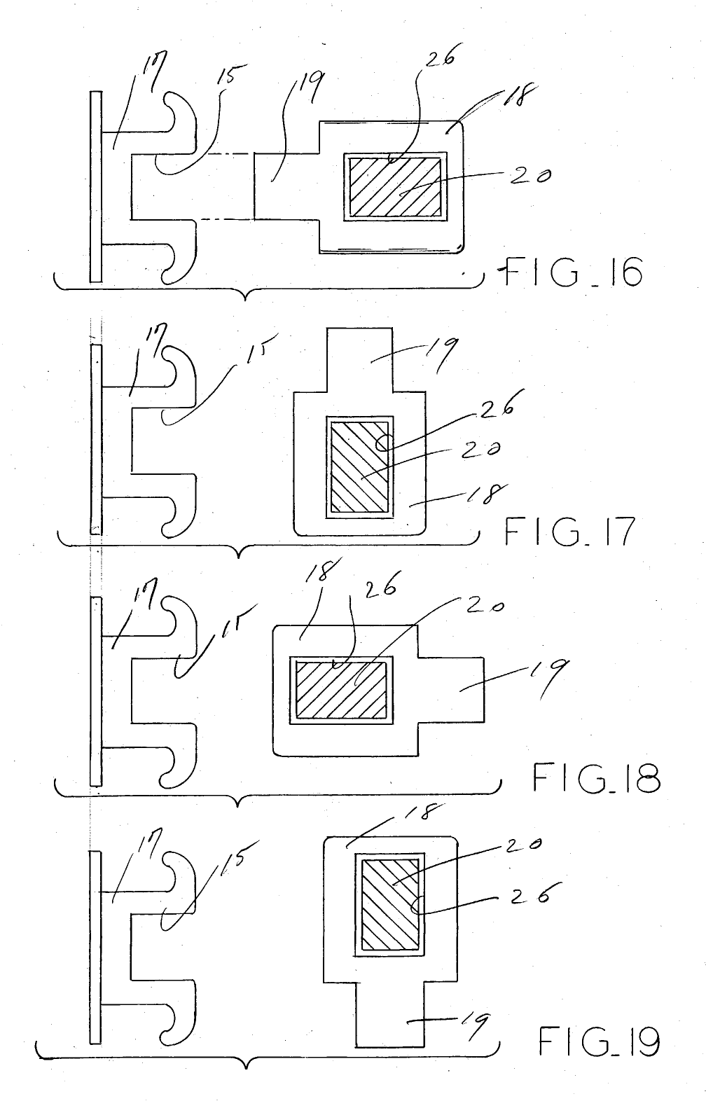

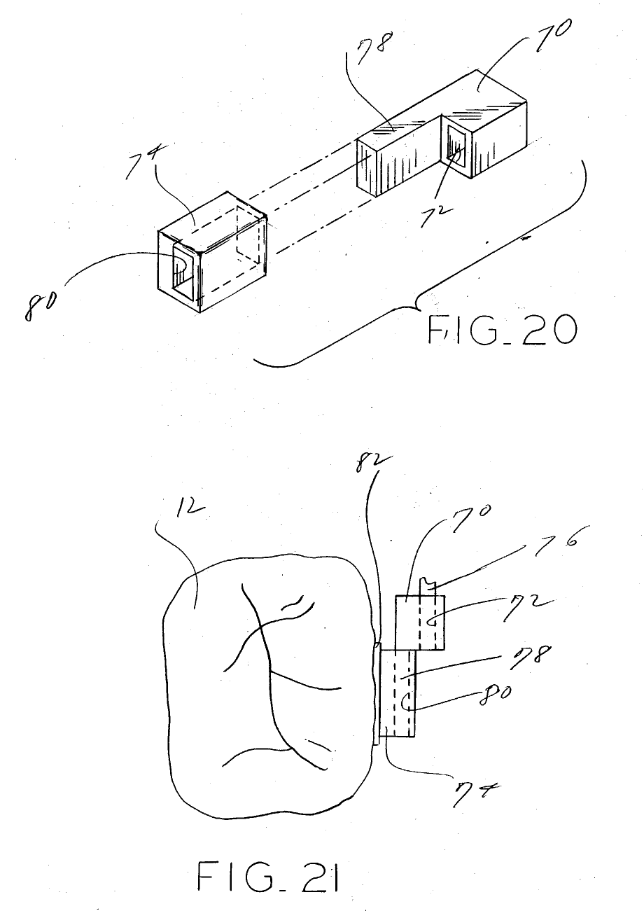

Referring now to FIG. 2 and FIGS. 16-19, there is shown the manner in which the torque is generated by secondary wire 20 on attachment 18, and therefore, by way of bracket 17, on a tooth 12. FIG. 16 shows an attachment 19 before it is secured to primary bracket 17. In this orientation, the secondary wire 20 has been threaded through attachment 18 and portion 19 is about to be placed in slot 15. Prior to inserting portion 19 in slot 15, however, it may be desired to twist secondary wire 20 through some desired angle in order to place the wire under a desired amount of tension to thereby generate a desired rotational force on attachment 18 by means of wire 20. For instance, FIG. 17 shows that the initial position of the attachment, just after secondary wire 20 is threaded through aperture 26 but before attachment 18 is rotated to its insertion position into bracket 17, is such that portion 19 is rotated 90° from the position of FIG. 16. Thus, after threading attachment 18 on wire 20, and anchoring the ends of wire 20 to hold them in position, attachment 18 is rotated through 90° and portion 19 is inserted into slot 15, thereby generating the desired torsional force on attachment 18. Similarly, if more torsional force were required, a further amount of rotation would be needed and, as seen in FIGS. 18 and 19, the initial position of portion 19 might be 180° or 270°, respectively, from the insertion position shown in FIG. 16. Alternatively, if no rotational torque were required, attachment 18 could be threaded on wire 20 and inserted so that no torsional force would be generated on attachment 18. Still further, any amount of rotation could be imparted to the attachment, by selecting an appropriate shape of wire 20 and shape of aperture 26. For instance, instead of a rectangular wire 20 shown in FIG. 3, the wire could be square or of a hexagonal shape or other types of shapes and the aperture in tube 18 could be similarly shaped to permit the wire to be threaded therethrough and rotated through any desired angle to generate the desired torsional force. This leaves the clinician with an almost unlimited amount of freedom to generate torsional forces.

As can be seen in FIG. 2, and as can be readily appreciated, when rotational torque is placed on secondary wire 20, rectangular wire 20 will transfer that torque over a relatively large distance to attachment 18. Since the torsional force acts over a fairly long distance, the torsional force will be a more constant force than could be obtained with conventional orthodontic appliances. This torque can be used to tip or rotate any given tooth, move a tooth buccally or lingually, or rotate a tooth. The attachment may be used with an undersized arch wire, i.e., an arch wire 16 which is not fully in slots 15 of brackets 14 as explained further hereinafter.

Referring further to FIG. 2, arrow 28 indicates a rotational force which can be generated on bracket 18 and tooth 12 by means of wire 20. Additionally arrow 30 is shown which indicates that an up or down force along a vertical axis can be generated by wire 20 on attachment 18, which force is transmitted to bracket 17 and from there to tooth 12. Still further arrow 32 indicates that a force along a horizontal axis can be generated by wire 20 on tooth 12. Again, that force will be transmitted to attachment 18 and from there by way of bracket 17 to tooth 12. Thus, the orthodontic appliance can be used to transmit forces along any axis to move, tip, or rotate tooth 12.

It can be readily appreciated that by the use of a primary bracket 14 and a secondary bracket or attachment 18, primary brackets 14 may be used to move the teeth laterally, i.e., in the lengthwise direction of arch wire 16, and primary bracket 17 may also move the teeth up and down by the application of torsional forces from secondary wire 20, i.e., perpendicularly to the longitudinal direction of the arch wire.

It may also be readily appreciated that the shape of the aperture 26 in attachment 18 is not restricted to the rectangular shape illustrated in FIG. 3. For instance, triangular, square, or other shapes may be used for aperture 26. The shape of wire 20 will need to match the shape of aperture 26 so that torque can be transmitted from wire 20 to attachment 18. The only requirement is that the shape of the aperture 26 matches the shape of wire 20 in such a way that a torsional force can be transmitted by wire 20 to attachment 18.

It may also be appreciated that attachment 18 could be fixedly secured to secondary wire 20. In that case, lateral forces, i.e., forces in the longitudinal direction of wire 20, could also be generated by secondary wire 20 and attachment 18.

A significant advantage of the instant invention is the fact that primary bracket 17 can remain attached to tooth 12 but that attachment 18 can be selected from a variety of attachments so that the appropriate force can be generated to act around a selected axis. Examples of such selection will be shown hereinafter.

FIGS. 6-8 further illustrate the forces which can be generated by wire 20 on tooth 12. FIG. 6 illustrates a plan view of tooth 12 wherein arrow 32 indicates a force directed along the horizontal axis to move the tooth in the mesial or distal planes. FIG. 7 indicates that, if secondary wire 20 is fixedly secured to attachment 18, a horizontally directed force can be generated by wire 20 on attachment 18, and therefore onto tooth 12, in the sideways direction as indicated by arrow 34.

FIG. 8 illustrates how a force can be generated by wire 20 along a vertical axis as indicated by arrow 30 to thereby move the tooth up or down.

FIGS. 9-12 illustrate various embodiments of attachment 18. FIGS. 9, 10 and 11 illustrate a rear view of attachment 18 taken from the mid sagital plane. FIG. 9 illustrates the embodiment of attachment 18 shown in FIG. 3. It can be seen that portion 19 is the same length as portion 36 of attachment 18 and is arranged substantially parallel thereto. However, portion 19 may be of any suitable length relative to portion 36. With this arrangement, the forces illustrated in FIG. 2 and FIGS. 6-8 can be generated. FIG. 10 shows an alternative arrangement wherein portion 19 runs at an angle relative to the longitudinal axis of attachment 18. With this arrangement, a rotational force can be generated on attachment 18 by means of wire 20 to rotate attachment 18 around an axis 38 as illustrated in FIG. 10 by arrow 39. Axis 38 runs from the front to the back of attachment 18. This would cause the tooth to tip do to the forces created. Similarly, FIG. 11 shows an arrangement and arrow 41 whereby the tipping force will be in the opposite direction of that generated by the arrangement of FIG. 10.

FIG. 12 shows a plan view of attachment 18 with a still different arrangement of portion 19. In this embodiment, portion 19 has an angular rear face 42. By way of this arrangement, the rotational force can be generated by wire 20 along a vertical axis 44 to cause rotation of a tooth along arrow 45. By arranging portion 19 with an angular rear face in the opposite direction, the direction of rotation can be reversed.

It can therefore be seen, as explained hereinabove, that the clinician, by appropriate selection of an attachment, can generate forces along and around any and all three major axes by means of the invention, as desired.

FIGS. 13-14 disclose another embodiment of the invention. In this embodiment, only a single wire 50 is used. Wire 50 is attached to attachment 18 but is of such dimension relative to bracket slots 15 that it can rotate within slots 15 of primary brackets 14. Thus, wire 50 can generate torque on attachment 18 and, by way of primary bracket 17 can transmit that torque to tooth 12. Further, wire 50 can work in all planes to generate linear forces along the three major axes on all other brackets 14 to be transmitted to teeth 12. However, wire 50 cannot generate torque or rotational force on brackets 14 as wire 50 can rotate relative to those brackets. This is illustrated in FIG. 14 where the wire 50 is shown as rotatable within bracket 14 as shown in by arrow 52. Wire 50 may be round or of any other suitable configuration. Forces along the major axes may be obtained as shown in connection with FIGS. 6, 7, and 8 by the action of wire 50 on brackets 14. The force along axis 34 can be generated by securing attachment 18 to any outside or remote anchor.

In another embodiment of the invention shown in FIG. 15, the primary bracket 14 and attachment 18 can be combined into a single attachment 60 to form an anchor for secondary wire 20 which can thereby be anchored to primary wire 16. Attachment 60 includes two apertures 62 and 64 in which a primary wire 16 and a secondary wire 20 are arranged. As shown in FIG. 15, attachment 18 is fastened on the primary arch wire 16 and is secured thereto at any convenient location, thereby providing a place for secondary wire 20 to be secured to attachment 60. Therefore, attachment 60 does not provide a rotational torque to a tooth but is intended to form an anchor for secondary wire 20.

Referring now to FIGS. 20 and 21, there is shown an alternate embodiment of the invention. Attachment 70 includes an aperture 72 and an extension 78. A tubular primary bracket 74 is shown which includes an aperture 80. As best seen in FIG. 21, extension 78 fits inside aperture 80. A secondary wire 76 fits inside aperture 72. Thus, the combination of bracket 74 and attachment 70 can be used to move the tooth. It can be seen that aperture 80 is rectangular and that extension 78 is similarly rectangular whereby torsional forces can be placed on bracket 74. Wire 20 is shown to be rectangular to fit through rectangular aperture 72 to generate a torsional force on attachment 70. As discussed hereinabove, the respective shapes of extension 78 and aperture 80 and wire 20 and aperture 72 can be varied, as desired. It is also possible to fixedly secure extension 78 in aperture 80 or to have extension 78 be slidable relative to bracket 74.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An orthodontic apparatus comprising:
a primary bracket;
an attachment secured to said primary bracket, said attachment having an aperture; and
a wire disposed within said aperture, said wire having a shape complementary to the shape of said aperture whereby a torque can be exerted on said attachment by said wire.

2. The orthodontic apparatus of claim 1 wherein said attachment comprises a tube.

3. The orthodontic apparatus according to claim 1 wherein said wire is rectangular in cross-section.

4. The orthodontic apparatus according to claim 1 wherein said secondary wire is made of a titanium containing alloy.

5. The orthodontic apparatus according to claim 1 wherein said attachment is slideable relative to said wire in the lengthwise direction of said wire.

6. The orthodontic apparatus according to claim 1, further including a second wire, said second wire secured to said primary bracket.

7. The orthodontic apparatus of claim 1, further including a plurality of secondary brackets and a second wire, said second wire secured to at least some of said plurality of said secondary brackets.

8. The orthodontic apparatus of claim 1 wherein said attachment includes a securement portion, said securement portion engagable with said primary bracket.

9. The orthodontic apparatus of claim 8 wherein said attachment has a longitudinal axis, said securement portion arranged at an angle relative to said longitudinal axis, whereby rotational movement may be generated on said attachment by said wire.

10. The orthodontic apparatus of claim 1 further including a plurality of secondary brackets, said wire rotatable relative to at least some of said plurality of secondary brackets.

11. An orthodontic bracket comprising a tube, said tube including an aperture adapted for engagement with an orthodontic wire, whereby rotational force can be generated on said bracket by said wire.

12. The orthodontic bracket of claim 11 wherein said bracket include a securement portion adapted to be engaged by a second bracket, said second bracket adapted to be secured to a tooth.

13. The orthodontic bracket of claim 12 wherein said securement portion is oriented at an angle relative to the axis of said tube.

14. The bracket of claim 11 wherein said tube includes a second aperture, said second aperture substantially parallel to said aperture, said second aperture adapted to be engaged with a second orthodontic wire.

15. The bracket of claim 12 wherein said securement portion is adapted to slide into an aperture in said second bracket.

16. The bracket of claim 12 wherein said securement portion is adapted to fit into an open slot in said second bracket.
